(19) United States
(12) Patent Application Publication
(10) Pub. No.: US 2025/0013965 A1
(43) Pub. Date: Jan. 9, 2025

(54) USING LARGE LANGUAGE MODEL(S) FOR LABOR UPSKILLING

(71) Applicant: Chevron U.S.A. Inc., San Ramon, CA (US)

(72) Inventor: Larry A. Bowden, JR., Houston, TX (US)

(21) Appl. No.: 18/348,302

(22) Filed: Jul. 6, 2023

(51) Int. Cl. G06Q 10/0639; G06Q 10/0631

(52) U.S. Cl. CPC G06Q 10/06393; G06Q 10/063112; G06Q 10/063114

(57) ABSTRACT

A system is described for using large language models for labor upskilling. The system includes the steps of identifying required skills, generating personalized training materials based on the learners' existing knowledge and skills, and evaluating the effectiveness of the training materials. This system can be applied to both hard skills and soft skills.

### TECHNICAL FIELD

The disclosed embodiments relate generally to a system and process for efficiently generating and delivering training material. In particular, the system and process make use of large language models to improve the generation and delivery of training material.

### BACKGROUND

As large language models (LLMs) become more advanced, they are able to generate algorithms and applications from text descriptions with increased accuracy, efficiency, and quality. This capability can revolutionize the way training is conducted. Traditional training methods, such as classroom instruction, e-learning, and self-guided learning, often suffer from being generic, non-personalized, and of poor quality. This can lead to low learner engagement and poor retention of information. In contrast, LLMs can provide personalized and targeted training materials that are adapted to individual learners, leading to better engagement and improved learning outcomes. Labor transformations, including digital transformation, requires that professionals with legacy competencies be upskilled to learn new skill sets that the workforce and markets demand. Thus, there exists a need for effective and efficient labor upskilling that leverages the capabilities of LLMs.

### SUMMARY

In accordance with some embodiments, a method for using large language models for labor upskilling is disclosed. The method includes the steps of identifying required skills, generating personalized training materials based on the learners' existing knowledge and skills, and evaluating the effectiveness of the training materials. This method can be applied to both hard skills (e.g., learning to use a new software suite) and soft skills (e.g., improving communication and leadership abilities).

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for labor upskilling;

FIG. 2 is an example process for labor upskilling;

FIG. 3A illustrates part of an example output of a step for labor upskilling;

FIG. 3B illustrates another part of an example output of a step for labor upskilling;

FIG. 3C illustrates an example code for labor upskilling;

FIG. 4A illustrates part of an example output of a step for labor upskilling;

FIG. 4B illustrates another part of an example output of a step for labor upskilling;

FIG. 4C illustrates another part of an example output of a step for labor upskilling;

FIG. 4D illustrates another part of an example output of a step for labor upskilling; and

FIG. 4E illustrates another part of an example output of a step for labor upskilling.

Like reference numerals refer to corresponding parts throughout the drawings.

### DETAILED DESCRIPTION OF EMBODIMENTS

Described below are methods, systems, and computer readable storage media that provide a manner of digital product delivery. These embodiments are designed to use large language model(s) to deliver digital products more efficiently and consistently.

Labor transformations, including digital transformation, requires that professionals with legacy competencies be upskilled to learn new skill sets that the workforce and markets demand. Currently available training is generic, non-personalized, and often of poor quality. Poor quality training is often ineffective because the learner will fail to retain the information. Personalized and, therefore, highly relevant training material will engage the learner more fully and improve information retention. To address this need, the disclosed embodiments utilize large language models (LLMs) to provide personalized, targeted upskilling to individuals based on their current knowledge and previous roles. By leveraging the capabilities of LLMs, such as reinforcement learning, supervised learning, and comparison learning, the resulting model can create personalized tutorials for targeted upskilling of professionals with legacy skill sets. This approach can be applied across various industries and job roles, catering to both hard skill and soft skill development.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The methods and systems of the present disclosure may, in part, use one or more models that are machine-learning algorithms. These models may be large language models (LLMs). LLMs are trained using large datasets of text, such as books, articles, or conversations. The LLM training process involves several steps. First, the LLM is trained using supervised learning, which involves collecting demonstration data and training a supervised policy. Next, the model is further trained using comparison learning, which requires a labeler to rank outputs from the supervised fine-tuned (SFT) model from best to worst. This information is used to train a reward model. Lastly, reinforcement learning is used to update the reward model, typically employing Proximal Policy Optimization (PPO) as a reinforcement learning algorithm. This comprehensive training process reduces bias in the LLM and ensures its effectiveness in generating personalized training materials.

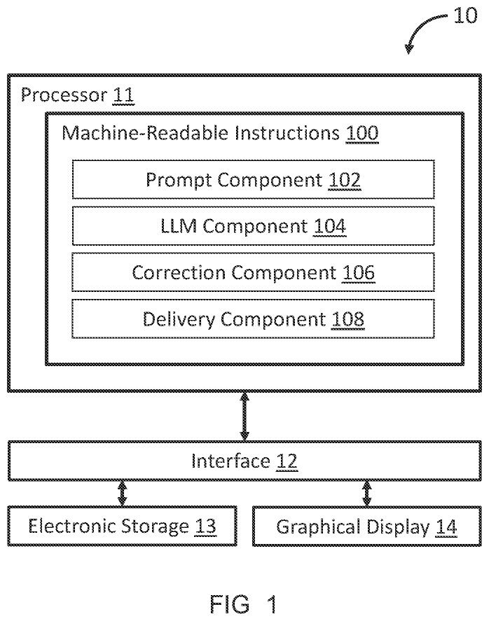

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The processor 11 will receive prompts from a user and execute one or more of the methods described herein to aid in the delivery of digital products.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to input prompts, and/or other information. For example, the electronic storage 13 may store information relating to LLM output, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to LLM output, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate digital product delivery. The machine-readable instructions 100 may include one or more computer program components. The machine-readable instructions 100 may include a prompt component 102, a LLM component 104, a correction component 106, a delivery component 108, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the prompt component 102 may be configured to receive prompts from the user.

The LLM component 104 may be configured to present prompts to the LLM which will generate the requested LLM output.

The correction component 106 may be configured to present LLM output to a user and receive corrections from the user. It may further provide the corrections to the LLM component 104 in order to receive corrected LLM output.

The delivery component 108 may be configured to present the LLM output to the electronic storage 13 and/or the graphical display 14.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

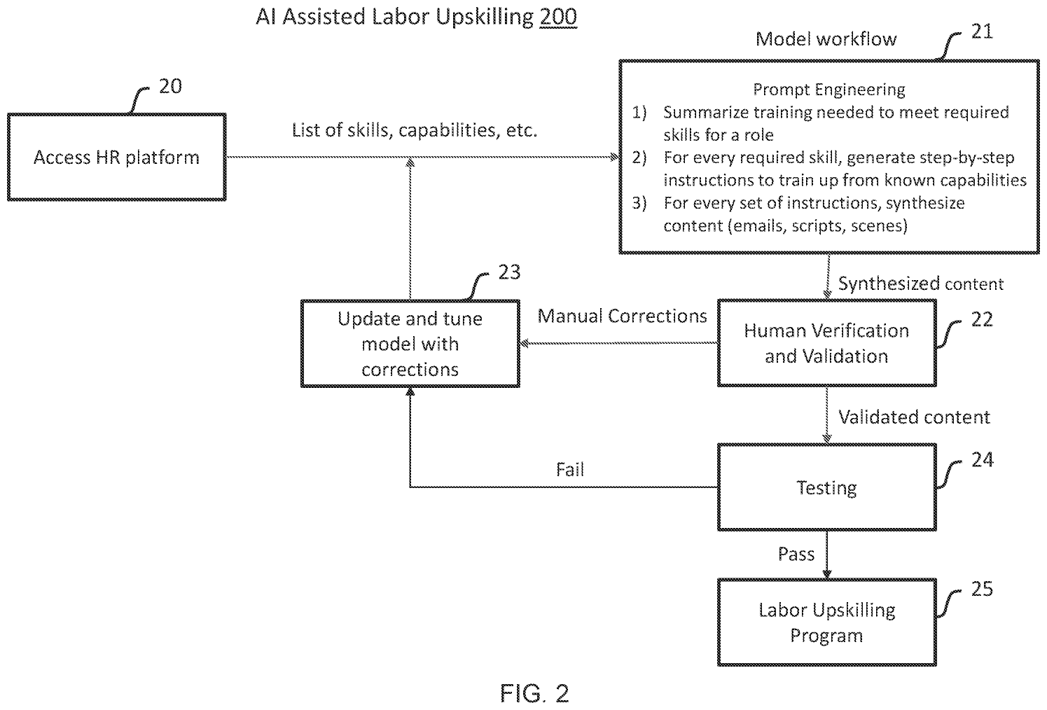

FIG. 2 illustrates an example process 200 for generating training material for labor upskilling. The LLM generates training materials by first identifying the required skills and the user's existing knowledge and skills. Then, the LLM selects appropriate content, such as videos, email messages, scripts, or other learning resources, based on the user's needs and context. The LLM synthesizes this content into a personalized training plan that includes step-by-step instructions, practical examples, and hands-on exercises tailored to the user's skill level.

Step 20 is accessing a human resources platform that contains information regarding roles needed and the skills required for those roles, as well as information on skills currently held by a candidate. This meeting will generate a list of needed skills, known capabilities, etc. for the needed labor upskilling. This information is provided to step 21 using a prompt structure for the LLM with the form of the desired output (type of training material), the known context (the known capabilities of the candidate), and the needed skills. The LLM will generate a list of training needed to meet required skills. The LLM will then further generate a set of step-by-step instructions for training for the required skills given the known capabilities of a candidate and synthesis content for the set of instructions. The content may be, for example, videos, email messages, and/or scripts or the like.

The synthesized content from the LLM may then be reviewed by a human for verification and validation at step 22. The human may make manual corrections at can optionally be used at step 23 to update and tune the model, then repeat step 21. Validated content from step 22 is passed to step 24 for testing. The testing may include, by way of example and not limitation, any of the following:
1. Test the accuracy of the model by providing it with labeled examples of desired output and comparing the output of the model to the desired output.
2. Test the effectiveness of the reinforcement learning techniques by providing the model with rewards for generating output that is similar to the desired output and comparing the output of the model to the desired output.
3. Test the ability of the model to generate text that is similar to the text in the dataset by providing the model with examples of text from the dataset and comparing the output of the model to the text in the dataset.
4. Test the ability of the model to generate text that is similar to the desired output by providing the model with examples of the desired output and comparing the output of the model to the desired output.
   If the testing fails, the process may perform step 23, 21, 22, and 24 again until the content passes and the training material is delivered at step 25.

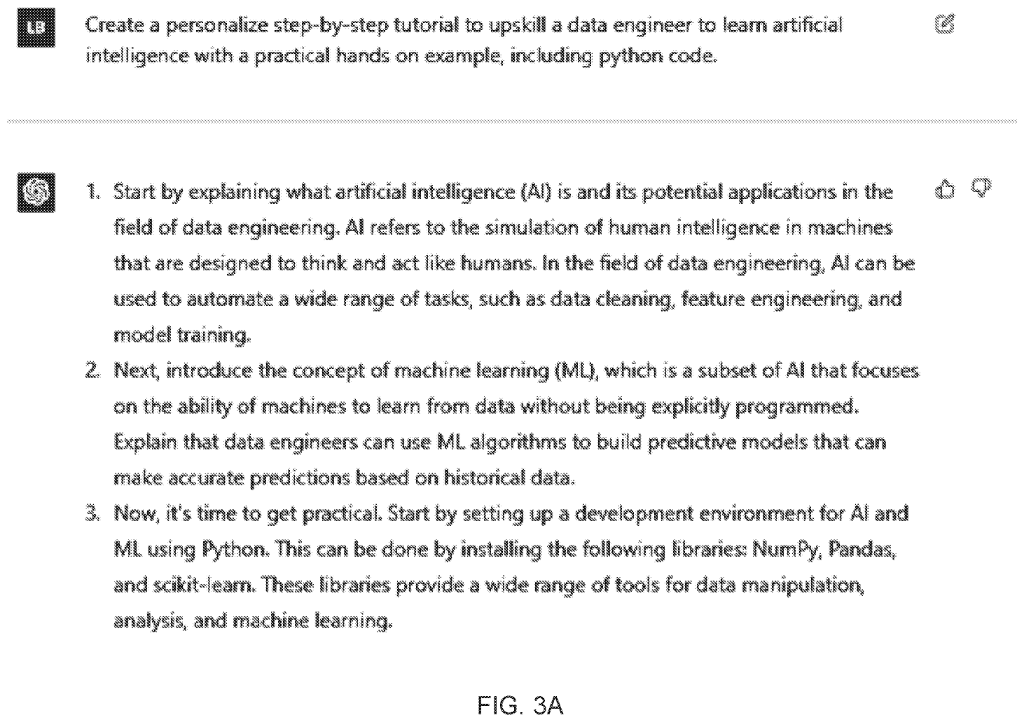

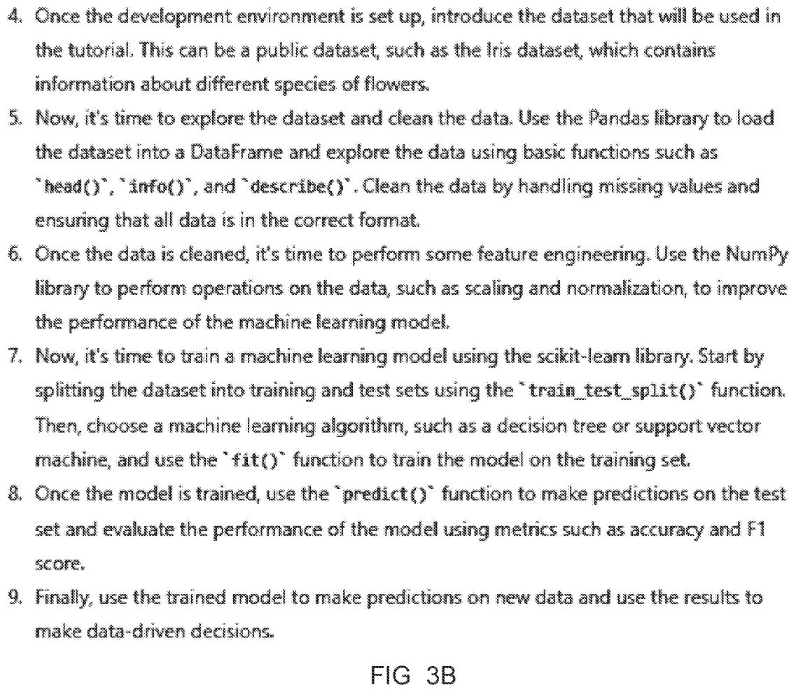

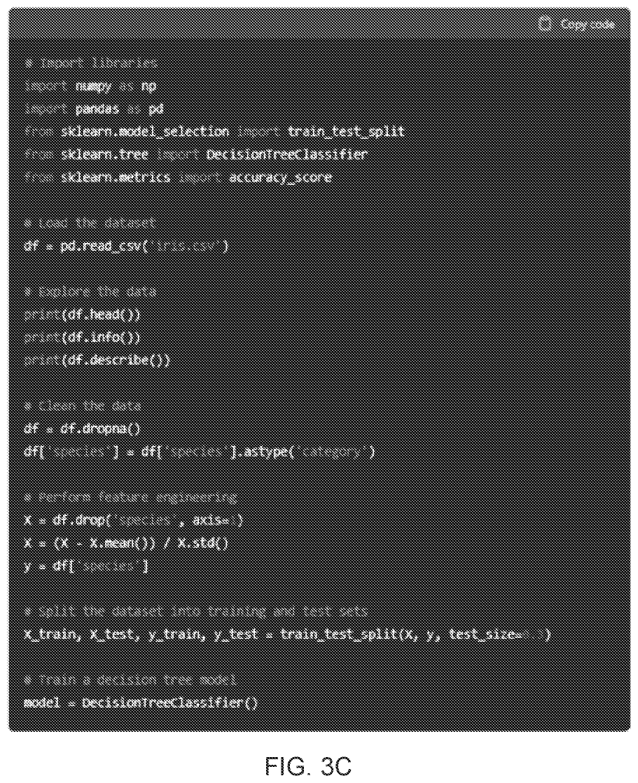

FIG. 3A, FIG. 3B, and FIG. 3C demonstrates an example of a training plan for hard skills generated by an LLM to fulfill one of the instructions generated by step 21. This code would be then validated (step 22) and tested (step 24). FIG. 3A shows the instructions provided to step 21, which are to “Create a personalized step-by-step tutorial to upskill a data engineer to learn artificial intelligence with a practical hands-on example, including python code.” The rest of FIG. 3A and FIG. 3B show the training material generated for the requested upskilling. FIG. 3C shows an example of the python code provided as a practical example.

When generating soft skills training material, the LLM may create a step-by-step tutorial that includes simulated dialogues and practical exercises, focusing on communication and leadership skills for an IT chapter manager with one year of experience. The training material can be adapted for different users and skill levels, ensuring a personalized and engaging learning experience. As an example of generating soft skills training material, the prompt for step 21 may be “Create a step-by-step tutorial, with practical examples that include simulated dialog, for an IT chapter manager with 1 year experience to improve communication for leadership as a soft skill.” Here again, the prompt structure is desired output (step-by-step tutorial, with practical examples that include simulated dialog), the known context (an IT chapter manager with 1 year experience), and the needed skills (to improve communication for leadership). In this case, the labor upskilling program may be:

### Output:

1. Start by identifying the communication challenges facing your leadership team. This may include things like lack of clear communication, misunderstandings, or a lack of empathy in communication.
2. Develop a clear and concise communication plan that outlines the goals and objectives of your leadership team, as well as the strategies and tactics you will use to improve communication.
3. Identify and prioritize the key communication skills that your leadership team needs to develop in order to improve their communication. These may include things like active listening, empathy, and effective feedback.
4. Provide training and development opportunities for your leadership team to build their communication skills. This may include workshops, training sessions, or online courses.
5. Encourage open and honest communication within your leadership team. This may include setting aside dedicated time for open discussions, fostering a culture of transparency and accountability, and encouraging leaders to be proactive in seeking feedback from their team members.
6. Monitor and evaluate the effectiveness of your communication plan on an ongoing basis. This may include conducting regular surveys or focus groups to gather feedback from your team, as well as tracking key metrics like team morale and productivity.
7. Make adjustments to your communication plan as needed based on the feedback and data you collect. This may include revising your communication goals and objectives, or implementing new strategies and tactics to improve communication.

### Simulated Dialog:

IT Chapter Manager: Hi team, I wanted to talk to you about improving our communication as a leadership team.
Leadership Team: Sure, that sounds like a good idea. What do you have in mind?
IT Chapter Manager: Well, we've identified some communication challenges that we need to address, and we've developed a communication plan that outlines our goals and strategies for improving our communication.
Leadership Team: That sounds great. What are some of the key communication skills that we need to focus on?
IT Chapter Manager: Some of the key skills we need to focus on include active listening, empathy, and effective feedback. We're going to provide training and development opportunities to help you build these skills.
Leadership Team: That's really helpful. How can we encourage open and honest communication within our team?
IT Chapter Manager: We're going to set aside dedicated time for open discussions, foster a culture of transparency and accountability, and encourage leaders to be proactive in seeking feedback from their team members. We're also going to monitor and evaluate the effectiveness of our communication plan on an ongoing basis.
Leadership Team: That all makes sense. Thank you for taking the time to help us improve our communication as a leadership team.

With the simulated dialog, a text to voice model may synthesize the speech for each actor (IT Chapter Manager, Leadership Team). In addition, image representations can be generated for each and animated with the voice. The models are open source, tortoise-tts is used for the voice generation. Text to image models are used to generate the images, and image/audio models are used to generate the video. There are third party platforms like synthesia or D-ID that produce the video/audio directly from the text instead of generating the audio, image separately and then another model to produce the video.

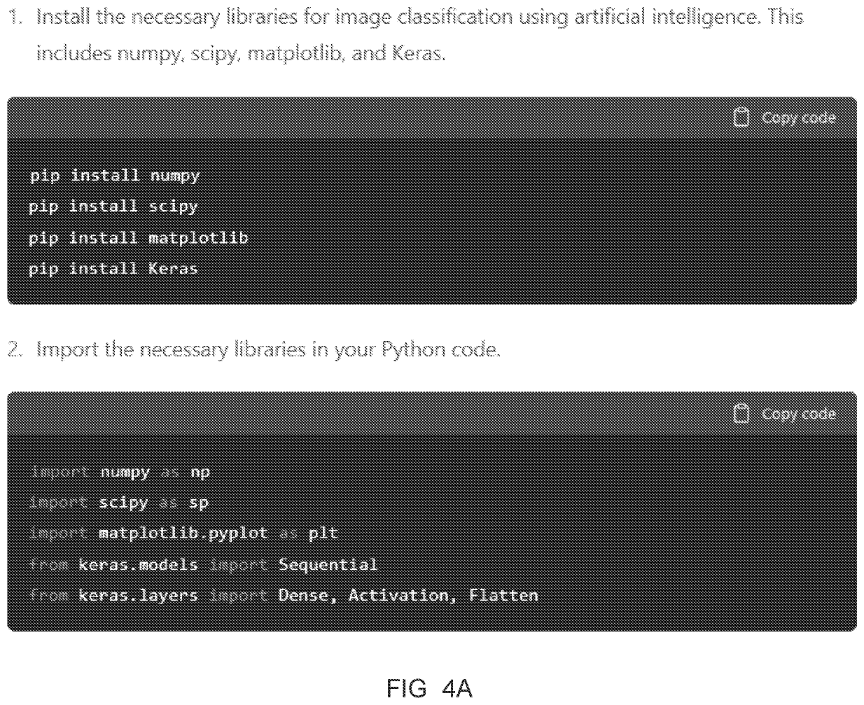

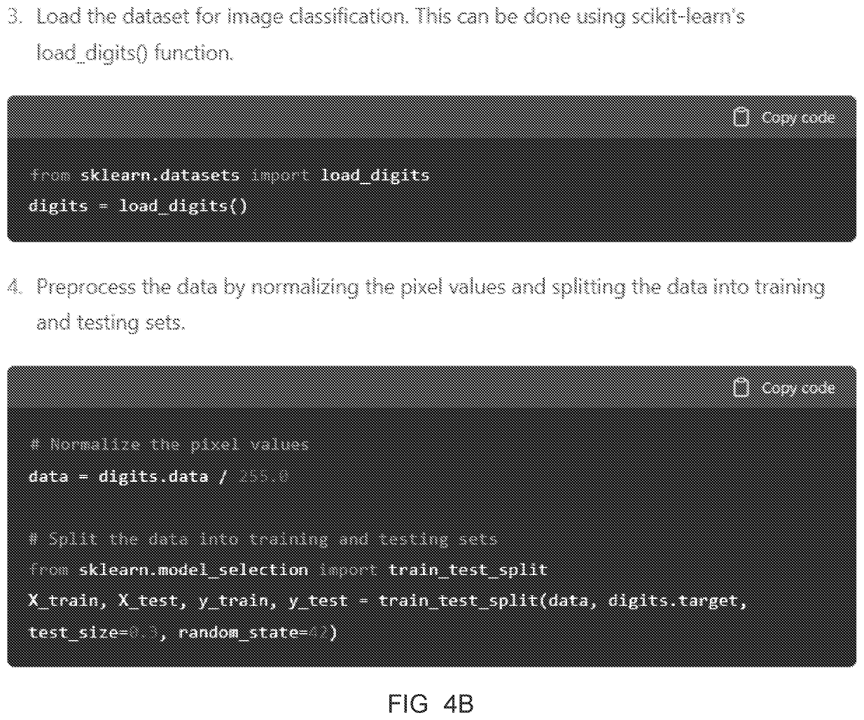

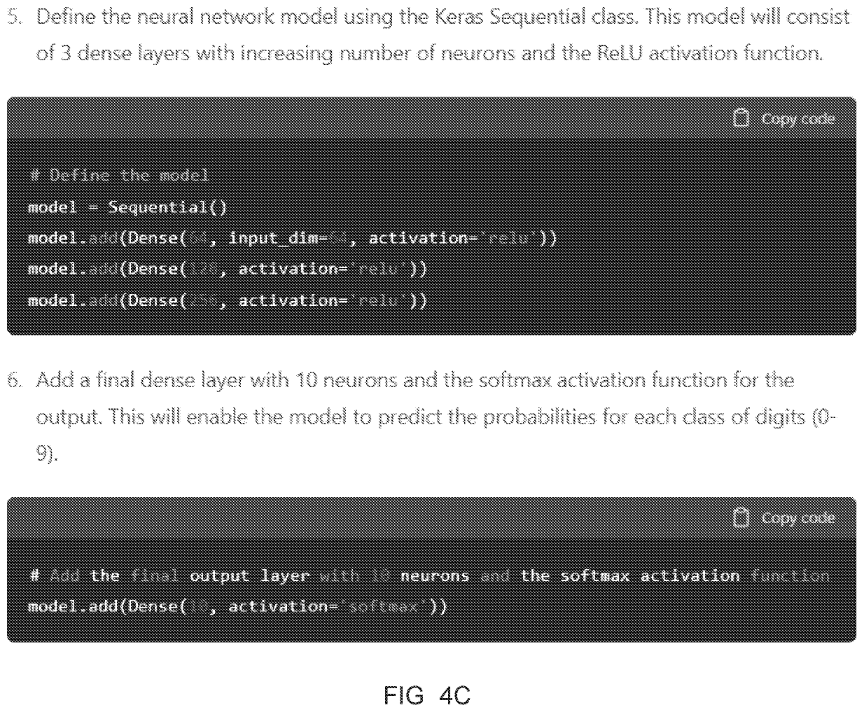

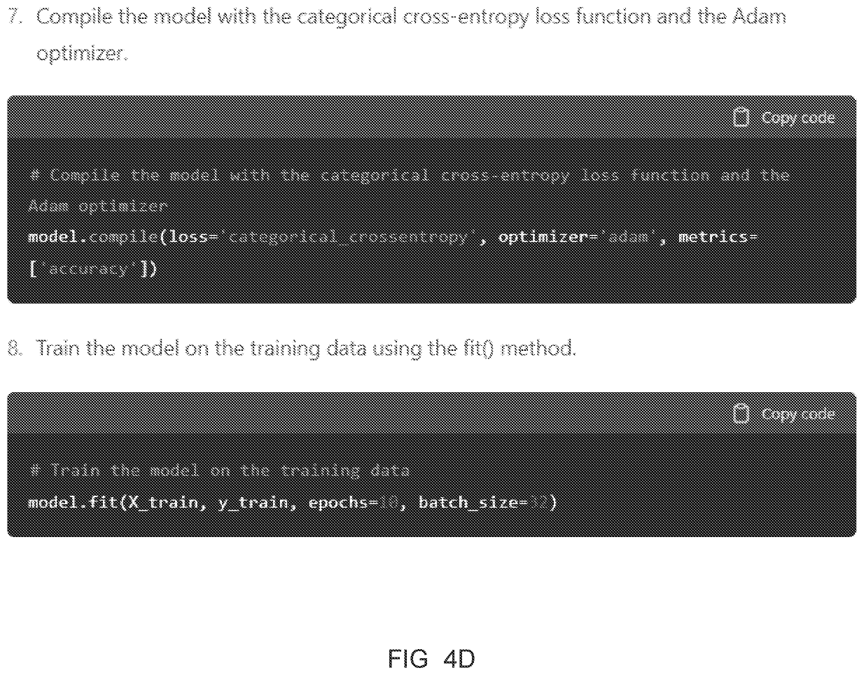

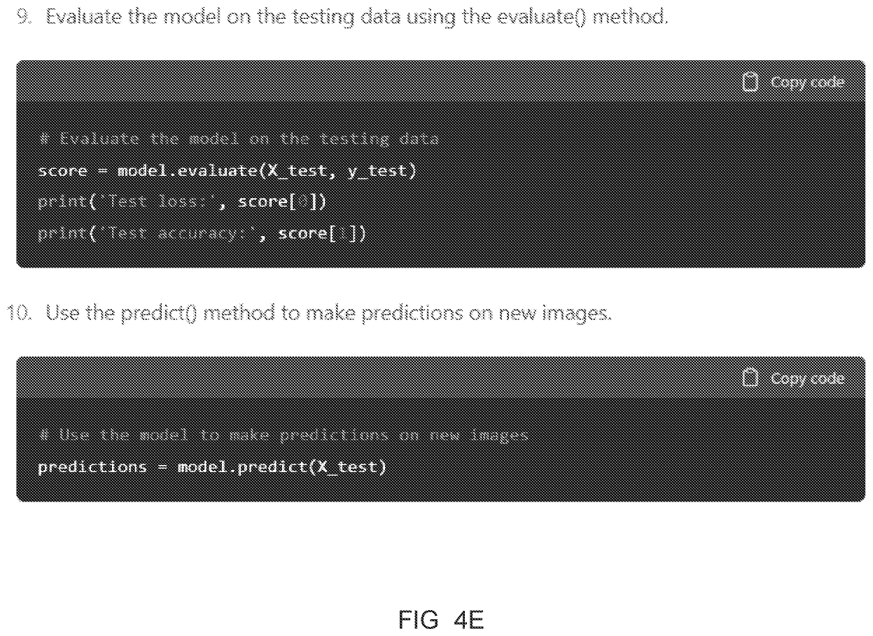

FIG. 4A-FIG. 4E show another example of method 200 for hard skills. Using the prompt “Create a step-by-step tutorial with python code examples for a data engineer with 3 years' experience to improve the skill of artificial intelligence for image classification” for step 21, FIG. 4A-FIG. 4E show the step-by-step tutorial.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a.” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising.” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1) A system for generating labor upskilling training material, comprising:
one or more processors;
non-transitory computer readable media; and
one or more programs, wherein the one or more programs are stored in the non-transitory computer readable media and configured to be executed by the one or more processors, the one or more programs including instructions that when executed by the one or more processors cause the system to:
a) receive a list of required skills and known capabilities;
b) provide the list to a large language model (LLM) configured to:
i) summarize training needed to meet the required skills;
ii) generate a set of instructions based on the training for each required skill starting from the known capabilities; and
iii) generate content for each set of instructions to create the labor upskilling training material.

2) The system of claim 1, further comprising a graphical display and additional instructions that when executed by the one or more processors cause the system to display one or more of the training needed to meet the required skills, the set of instructions, or the content for each set of instructions on the graphical display.

3) The system of claim 2 wherein a user validates the one or more of the training needed to meet the required skills, the set of instructions, or the content for each set of instructions displayed on the graphical display and further executes instructions that when executed by the one or more processors cause the system to test the content for each set of instructions to generate tested content.

4) The system of claim 3 wherein the tested content is output as the labor upskilling training material and is stored in the non-transitory computer readable media.

5) A computer-implemented method of generating labor upskilling training material, comprising:
a) receiving a list of required skills and known capabilities;
b) providing the list to a large language model (LLM) configured to:
i) summarize training needed to meet the required skills;
ii) generate a set of instructions based on the training for each required skill starting from the known capabilities; and
iii) generate content for each set of instructions to create the labor upskilling training material.

6) The method of claim 5 further comprising displaying one or more of the training needed to meet the required skills, the set of instructions, or the content for each set of instructions on a graphical display.

7) The method of claim 6 wherein a user validates the one or more of the training needed to meet the required skills, the set of instructions, or the content for each set of instructions displayed on the graphical display and the method further comprises testing the content for each set of instructions to generate tested content.

8) The method of claim 7 wherein the tested content is output as the labor upskilling training material and is stored in non-transitory computer readable media.
